(19) United States
(12) Patent Application Publication
(10) Pub. No.: US 2024/0202815 A1
(43) Pub. Date: Jun. 20, 2024

(54) SYSTEM AND METHOD FOR PROVIDING BANKING SERVICES TO CRYPTOCURRENCY ACCOUNTS

(71) Applicant: NCR Corporation, Atlanta, GA (US)

(72) Inventor: Bryan Walser Nonni, Atlanta, GA (US)

(21) Appl. No.: 18/082,095

(22) Filed: Dec. 15, 2022

(51) Int. Cl. G06Q 40/02; G06Q 20/10; G06Q 20/38; G06Q 40/12

(52) U.S. Cl. CPC G06Q 40/02; G06Q 20/102; G06Q 20/381; G06Q 40/125

(57) ABSTRACT

A system and method for interfacing between a financial institution and a cryptocurrency exchange. Payroll payment information and associated funds are received at a back-end API for direct deposit to a bank account and a cryptocurrency account. Back-end API causes a first amount to be deposited to the bank account, converts a second amount to cryptocurrency funds, and causes the cryptocurrency funds to be deposited into the cryptocurrency account. Bill payment information is received at back-end API specifying a first amount to be withdrawn from a bank account and a second amount to be withdrawn from a cryptocurrency account. Back-end API causes the first amount to be withdrawn from the bank account, causes the second amount to be withdrawn from the cryptocurrency account, converts the cryptocurrency funds to fiat money, combines the two amounts, and forwards the combined amount to a bill pay company to complete the bill payment.

### FIELD

This disclosure relates generally to a system and method for providing banking services to cryptocurrency accounts, and more particularly to a system and method for interfacing between a financial institution such as a bank and a cryptocurrency exchange account which provides a cryptocurrency exchange account holder with access to the same types of banking services available to bank account holders.

### BACKGROUND

A cryptocurrency is a digital currency that works as a medium of exchange through a computer network not reliant on any central authority, such as a government or bank, to uphold or maintain it. Cryptocurrency is a decentralized system for verifying that parties to a transaction have the money they claim to have, eliminating the need for traditional intermediaries, such as banks, when funds are being transferred between two entities. Individual ownership records are stored in a digital ledger, a computerized database using strong cryptography to secure transaction records that is based on blockchain technology. A cryptocurrency exchange is a business that allows customers to trade cryptocurrencies for other assets, such as conventional fiat money or other digital currencies.

Cryptocurrencies continue to grow in popularity and become more commonplace with consumers. As cryptocurrencies become more widely used among consumers, banks and other financial service providers are becoming increasingly interested in making cryptocurrency services and products available to their customers. However, because of regulatory constraints, banks are currently limited in the types of cryptocurrency services they may directly provide. This makes access to cryptocurrencies via a traditional banking interface, such as an automated teller machine (ATM) difficult to offer. As a result, consumers are currently forced to use unfamiliar dedicated cryptocurrency systems and interfaces separately from how they access their traditional bank accounts, e.g., via a bank ATM. In addition, consumers with cryptocurrency (crypto) accounts are not able to access payroll and bill pay services in the same manner as available to consumers with bank accounts at conventional financial institutions.

In addition, banking may become more open and less regulated in the future. Traditional banks will need the ability to control custody of digital assets for their customers as regulators continue to reduce restrictions and banks continue to forge partnerships with companies that offer these services. A natural consequence of these partnerships and shift in banking will be a desire by consumers for all of the normal banking services available from a bank but using their new digital assets.

Accordingly, because of the drawbacks recited above, there is a need for an improved a system and method for interfacing between a financial institution such as a bank and a cryptocurrency exchange account in order to provide access to payroll and/or bill pay services for those with cryptocurrency accounts.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system for interfacing between a financial institution such as a bank and a cryptocurrency exchange account according to the present disclosure;

FIG. 2 is a block diagram of a server system for hosting an application program interface according to the present disclosure;

FIG. 3 is a flowchart of a method for providing traditional banking services for cryptocurrency exchange accounts according to a first aspect of the present disclosure; and

FIG. 4 is a flowchart of a method for providing traditional banking services for cryptocurrency accounts according to a second aspect of the present disclosure.

### DETAILED DESCRIPTION

In the present disclosure, like reference numbers refer to like elements throughout the drawings, which illustrate various exemplary embodiments of the present disclosure.

The present disclosure describes a system and method for interfacing between a financial institution such as a bank and a cryptocurrency exchange account which provides a cryptocurrency account holder with access to the same types of banking services available to bank account holders via a same or similar interface. The system and method provide a solution based on back-end processing (between the financial institution and the cryptocurrency exchange) that converts amounts of fiat money to cryptocurrency, and vice versa, in order to provide traditional banking services to a user having a cryptocurrency account. This back-end processing allows the user access to services that provide direct deposit of their paycheck (in part or in whole) into a cryptocurrency exchange account and which paying utility and/or service provider bills from that cryptocurrency exchange account.

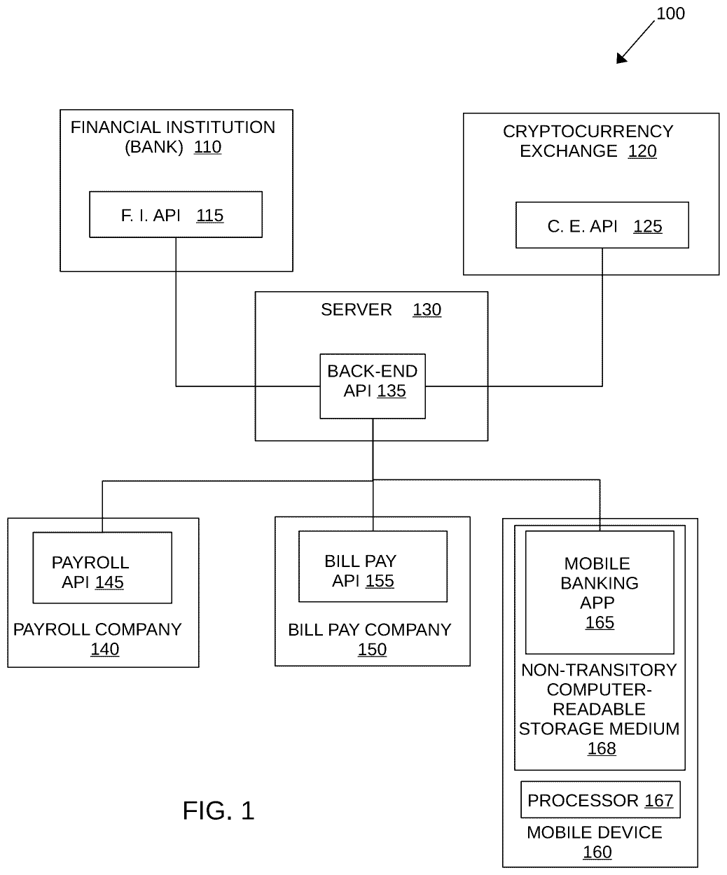

Referring now to FIG. 1, the system 100 provides a back-end application programming interface (API) 135 which runs on, for example, a server 130 that interfaces between a financial institution API 115 at a financial institution (bank) 110 and a cryptocurrency exchange API 125 at a cryptocurrency exchange (platform) 120. In one case, the integration services provided via the back-end API 135 (discussed below) may be provided by a third-party independent from the financial institution 110 and the cryptocurrency exchange 120, and in this situation, server 130 may be based remotely from the financial institution and from the cryptocurrency exchange 120, for example as a cloud-based server. In another case, the integration services may be provided by the cryptocurrency exchange 120 and in this situation the server 130 may be located at the cryptocurrency exchange 120 (and may be, but is not required to be, the same server that runs the cryptocurrency exchange API 125). In yet another case (in the event that banking regulations are changed to so allow this), the integration services may be provided by the financial institution 110 and in this situation the server 130 may be located at the financial institution 110.

The back-end API 135 is communicatively coupled to a financial institution API 115 that runs on a server at the financial institution 110 and to a cryptocurrency exchange API 125 that runs on an associated processor of a server at the cryptocurrency exchange 120. In addition, the back-end API 135 is communicatively coupled to a payroll API 145 provided at a payroll company 140 and/or to a bill pay API 155 located at a bill pay company 150. The back-end API 135 may also be communicatively coupled to a front-end API/mobile banking application (app) 165 operating on a mobile device 160. The mobile banking app 165 is provided on a non-transitory computer-readable storage medium 168 (e.g., a hard disk as discussed below) and is executed by an associated processor 167 to provide the features discussed below.

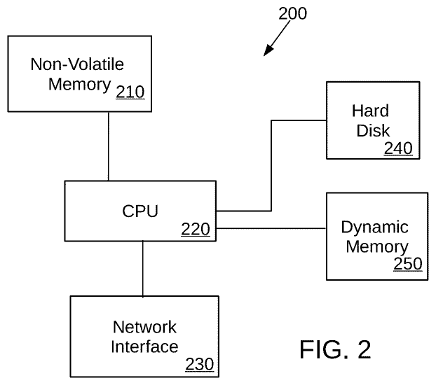

Each server discussed with respect to FIG. 1 may correspond to a server 200 as shown in FIG. 2. Each server 200 is preferably a hardware-based computing system which includes one or more central processing units 220 (processors), a network interface 230, at least one hard disk (HD) 240, volatile memory 250, and non-volatile memory 210. The non-volatile memory 210 may include a basic input/output system (BIOS) used to initiate a boot of the server 200. The HD 240 may be any type of non-volatile memory device (i.e., a non-transitory computer-readable storage medium) used to hold an operating system for a computer-based system (and application programs including APIs) and the term “hard disk” as used herein is intended to be broadly defined to include both electro-mechanical data storage devices and solid-state drives. The HD 240 holds the programs (software applications) which load into volatile memory 250 upon boot of the operating system to provide the functionality of such programs, including the one or more of the APIs discussed herein. It is to be noted that the components are shown schematically in greatly simplified form, with only those components relevant to understanding of the embodiments being illustrated. The various components (that are identified in the FIG. 2) are illustrated and the arrangement of the components is presented for purposes of illustration only. It is to be noted that other arrangements with more or less components are possible without departing from the teachings of the system and method presented herein. In one presently preferred embodiment, server 200 comprises a computing system adapted to run a secure version of the Microsoft Windows® operating system or a secure Linux distribution.

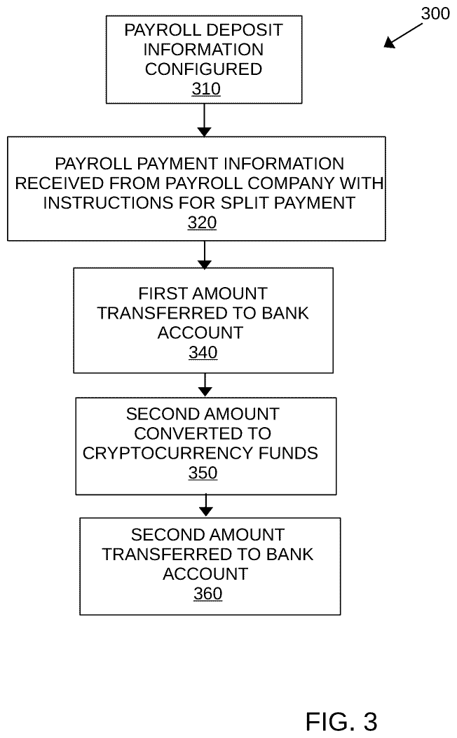

Referring now to FIG. 3, a flowchart 300 is shown that describes the process involved with payroll payments. At step 310, an employee configures deposit information for their regular payroll payments. This can be done via an internal company process, whereby the employee provides banking information that is then forwarded to the payroll company. In this situation however, the banking information includes information about both a traditional-style bank account at a financial institution (e.g., financial institution 110) and about a cryptocurrency account at a cryptocurrency exchange (e.g., cryptocurrency exchange 120). This could also be done via a web site provided by the payroll company or a mobile banking app 165 provided by the payroll company that may be installed on a mobile device 160 of the employee. In either case, the payroll deposit information includes both the account information (a bank account at the financial institution and a cryptocurrency account at the cryptocurrency exchange) and an indication of how the payroll payments are to be apportioned between the financial institution and the cryptocurrency exchange (e.g., 50% to each). This apportionment can range from 100% to the bank account and nothing to the cryptocurrency account to nothing to the bank account and 100% to the cryptocurrency account. Thereafter, at step 320 and at each regular payroll payment date, the back-end API 135 may receive payment information for a particular employee that includes funds for the employee's complete payroll payment in fiat money and information for two payments, a first payment to a bank account at a financial institution and a second payment to a cryptocurrency account at a cryptocurrency exchange—where the two payments are the apportioned amount of the total pay due to the employee as specified by the employee in step 310. At step 340, the back-end API forwards deposit information and funds in fiat money to the financial institution 110 so that the first payment is deposited in the bank account of the employee. At step 350, the back-end API confers the amount of the second payment from fiat money to cryptocurrency funds, and at step 360, the back-end API forwards deposit information and the cryptocurrency funds to the cryptocurrency exchange 120 so that the second payment is deposited in the cryptocurrency account of the employee. The method of flowchart 300 provides a direct deposit solution for employees that allows them to apportion their pay to their own traditional and cryptocurrency accounts.

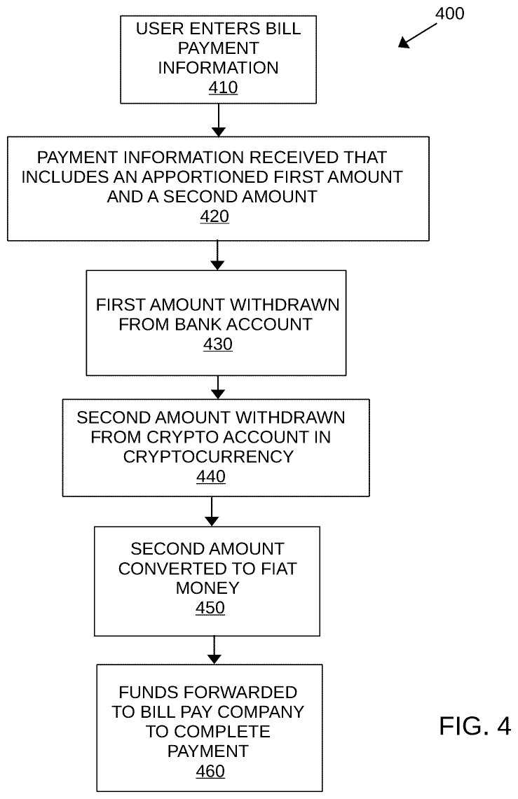

Referring now to FIG. 4, a flowchart 400 is shown that describes the process involved in enabling bill pay payments according to the system and method of the present disclosure. In a first step 410, a user enters bill payment information via an account at the bill pay company (e.g., bill pay company 150). This may be done via a web interface provided by the bill pay company 150 or via a mobile banking app 165 installed on the mobile device of the user. The account of the user is preferably set up to identify two accounts, a bank account at a financial institution and a cryptocurrency account at a cryptocurrency exchange. The bill payment information identifies the payee and may include an amount of the payment (for a one-time payment or regular payments of the same amount) and also includes apportionment information that specifies how the funds to cover the payment are to be drawn from the two separate user accounts (e.g., 50% from each). The user may also specify the date for the payment or authorize that payments may be automatically drawn from the account by the payee.

Thereafter, at step 420, the back-end API 135 receives payment information from the bill pay company that includes a first amount to be drawn from the bank account of the user at the financial institution and a second amount to be drawn from the cryptocurrency account of the user at the cryptocurrency exchange. As evident, in some cases the first amount may be zero and the second amount may be the entire amount of the payment, and vice versa. The back-end API 135 then withdraws the first amount of funds from the bank account of the user at step 430 (in fiat money) and withdraws the second amount of funds from the cryptocurrency account of the user at step 440 (in cryptocurrency). The back-end API 135 then converts the cryptocurrency funds to fiat money at step 450, and combines the two sets of fiat money. The back-end API 135 then forwards the combined set of funds (i.e., the complete payment amount for the current bill payment) to the bill pay company 150 at step 460. The bill pay company 150 receives the funds and forwards them to the payee to complete the payment process.

The back-end API 135 may preferably be provided with specifications that allow any third-party cryptocurrency exchange to directly interface on the crypto side and any financial institution customer to directly interface from the traditional banking side. The back-end API 135 provides automated and real-time conversion between fiat money and digital cryptocurrency. The back-end API 135 provides advantages to both financial institutions and to cryptocurrency exchanges by adding features and inter-compatibility not previously available to each. For example, financial institutions will gain exposure to the crypto market, retain customers who might otherwise depart for a crypto-based account, and gain customers interested in a dual banking/crypto solution. The back-end API 135 also provides a new third-party type intermediary that can interact between the financial institutions and cryptocurrency exchanges and provide the hardware/software needed to implement the system and method of the present disclosure.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A method for interfacing between a financial institution and a cryptocurrency exchange to allow direct deposit of a payroll payment, comprising:
receive payroll payment information for an employee and associated funds from a payroll company at a back-end application programming interface running on an associated processor, the payroll payment information specifying a first amount in fiat money to be deposited to an account of the employee at the financial institution and a second amount in fiat money to be deposited to an account of the employee at the cryptocurrency exchange;
communicate, via the back-end application programming interface running on the associated processor, with the financial institution to cause the first amount in fiat money to be deposited to the account of the employee at the financial institution;
convert, via the back-end application programming interface running on the associated processor, the second amount in fiat money to an amount of cryptocurrency funds; and
communicate, via the back-end application programming interface running on the associated processor, with the cryptocurrency exchange to cause the second amount in cryptocurrency funds to be deposited into the account of the employee at the cryptocurrency exchange.

2. A method for interfacing between a financial institution and a cryptocurrency exchange, comprising:
receive bill payment information for a user from a bill pay company at a back-end application programming interface running on an associated processor, the bill payment information specifying a first amount in fiat money to be withdrawn an account of the user at the financial institution and a second amount in fiat money to be withdrawn from an account of the user at the cryptocurrency exchange;
communicate, via the back-end application programming interface running on the associated processor, with the financial institution to cause the first amount in fiat money to be withdrawn from the account of the user at the financial institution;
communicate, via the back-end application programming interface running on the associated processor, with the cryptocurrency exchange to cause the second amount in cryptocurrency funds to be withdrawn from the account of the user at the cryptocurrency exchange;
convert, via the back-end application programming interface running on the associated processor, the second amount in cryptocurrency funds to a second amount of fiat money, and combine the first amount of fiat money with the second amount of fiat money into a complete payment amount of fiat money; and
forward, via the back-end application programming interface running on the associated processor, the complete payment amount of fiat money to the bill pay company to complete a current bill payment.

3. A system for interfacing between a financial institution and a cryptocurrency exchange, comprising:
a server having a processor and a non-transitory computer-readable storage medium, the server coupled to a financial institution and to a cryptocurrency exchange, the non-transitory computer-readable storage medium having executable instructions for a back-end application programming interface, which when executed, cause the processor to perform the following operations:
receive payroll payment information for an employee and associated funds from a payroll company, the payroll payment information specifying a first amount in fiat money to be deposited to an account of the employee at the financial institution and a second amount in fiat money to be deposited to an account of the employee at the cryptocurrency exchange;
communicate with the financial institution to cause the first amount in fiat money to be deposited to the account of the employee at the financial institution;
convert the second amount in fiat money to an amount of cryptocurrency funds; and
communicate with the cryptocurrency exchange to cause the second amount in cryptocurrency funds to be deposited into the account of the employee at the cryptocurrency exchange.

4. A system for interfacing between a financial institution and a cryptocurrency exchange, comprising:
a server having a processor and a non-transitory computer-readable storage medium, the server coupled to a financial institution and to a cryptocurrency exchange, the non-transitory computer-readable storage medium having executable instructions for a back-end application programming interface, which when executed, cause the processor to perform the following operations:
receive bill payment information for a user from a bill pay company, the bill payment information specifying a first amount in fiat money to be withdrawn an account of the user at the financial institution and a second amount in fiat money to be withdrawn from an account of the user at the cryptocurrency exchange;
communicate with the financial institution to cause the first amount in fiat money to be withdrawn from the account of the user at the financial institution;
communicate with the cryptocurrency exchange to cause the second amount in cryptocurrency funds to be withdrawn from the account of the user at the cryptocurrency exchange;
convert the second amount in cryptocurrency funds to a second amount of fiat money, and combine the first amount of fiat money with the second amount of fiat money into a complete payment amount of fiat money; and
forward the complete payment amount of fiat money to the bill pay company to complete a current bill payment.
